(19) United States
(12) Patent Application Publication
(10) Pub. No.: US 2003/0158782 A1
(43) Pub. Date: Aug. 21, 2003

(54) Electronic processing system

(76) Inventors: Scott Thomson, Macclesfield (GB); Andrew David Bailey, Macclesfield (GB); David North, Macclesfield (GB); Elizabeth Joy Sansom, Macclesfield (GB); Andrew Blackburn, Macclesfield (GB); Anne Walters, Macclesfield (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/276,435

(22) PCT Filed: May 17, 2001
(86) PCT No.: PCT/GB01/02159

(30) Foreign Application Priority Data
May 17, 2000 (GB) 0011915.6
Apr. 11, 2001 (GB) 0109134.5

(51) Int. Cl. G06F 17/60

(52) U.S. Cl. 705/17

(57) ABSTRACT

The invention concerns an electronic processor for use in processing cash transactions comprising an electronic processor and a database. The processor has: 1) an interface for receiving a request from a member using the system for generating a coded number representing a desired cash value to be purchased at a remote terminal, for receiving a request that a number previously allocated may be redeemed, for transmitting to the remote terminal a generated number and for transmitting a message to a terminal indicating that a received request for redemption is valid; 2) a validation section for determining whether or not received requests are valid; 3) a number generation section for generating a coded number in response to a valid request; and 4) a storage section for storing each number generated in response to a valid request in a first table of the database and for storing the total value of cash represented by issued coded numbers which have not been redeemed in a Fund table and for transferring a coded number the redemption of which has been validated to a second table and decrementing the total value in the Fund table by the value represented by each coded number for which a validated redemption request is received so that every coded number issued can never cause more than one increase in the value represented in the fund table and every coded number redeemed can cause only one decrease in the stored value.

The present invention concerns an electronic processing system for handling cash transactions in a manner which is both highly flexible and extremely secure.

There has been a substantial increase in the last few decades of the range of options which are available to people for handling and transferring cash. For example there has been almost exponential rise in the use of credit and debit cards in countries and in recent years there has also taken place a substantial and increasing market in which goods are purchased over the Internet. As a result of these developments the use of standard cheques drawn on individuals bank accounts is in relative decline. There are however other paper-based transactions such as vouchers for redemption within retail stores which have continued to grow in popularity. Thus even with the relative decline in the issuance of cheques a substantial number of financial transactions based on paper are still carried out every year.

It has also long been appreciated that paper-based transactions such as cheques or gift vouchers for redemption are both costly to administer and prone to forgery. In addition as businesses world-wide increasingly out-source non-core activities to specialist third parties, it is apparent that there is a need for a flexible and secure money transfer system for handling even relatively small sums of money so as to accommodate retail transactions which at the lower level can correspond to single inexpensive items in a retail store.

Another problem which has arisen with regard to electronic money transactions is that there are still many individuals who do not wish to divulge their banking details to a retailer when not present at the retailer. Such individuals are accordingly limited in their ability to utilise to the full the functionality of the Internet. Additionally making purchases over the Internet, with potential cash savings' is not available to people who do not possess credit or debit cards. Thus current money transfer systems effectively disenfranchise these two groups of potential customers.

Finally, one of the consequences of the rise in electronic cash transfers is that retailers and credit card issuers have to follow time-consuming anti-fraud procedures for all purchases.

Thus the present invention is particularly concerned in finding a system which is extremely secure, which at the same time is efficient in its use of data storage space and processing time, and can be used over the Internet, the telephone or in physical stores.

In accordance with one aspect of the invention there is provided an electronic processor system for use in processing cash transactions comprising an electronic processor and a database, the processor comprising:

1) an interface for receiving a request from a member using the system for generating a coded number representing a desired cash value to be purchased at a remote terminal, for receiving a request that a number previously allocated may be redeemed, for transmitting to the remote terminal a generated number and for transmitting a message to a terminal indicating that a received request for redemption is valid;

2) a validation section for determining whether or not received requests are valid;

3) a number generation section for generating a coded number in response to a valid request; and

4) a storage section for storing each number generated in response to a valid request in a first table of the database and for storing the total value of cash represented by issued coded numbers which have not been redeemed in a Fund table and for transferring a coded number the redemption of which has been validated to a second table and decrementing the total value in the Fund table by the value represented by each coded number for which a validated redemption requested is received so that every coded number issued can never cause more than one increase in the value represented in the final table and every coded number redeemed can cause only one decrease in the stored value.

Preferably the number generating section is adapted to generate the cash voucher number in a manner which incorporates other details with regard to the subsequent redemption of the cash voucher.

The present invention also includes a method of processing cash transactions, a terminal for use with the processor system as set out above.

In order that the present invention may be more readily understood an embodiment thereof will now be described by way of example and with reference to the accompanying drawings, in which:

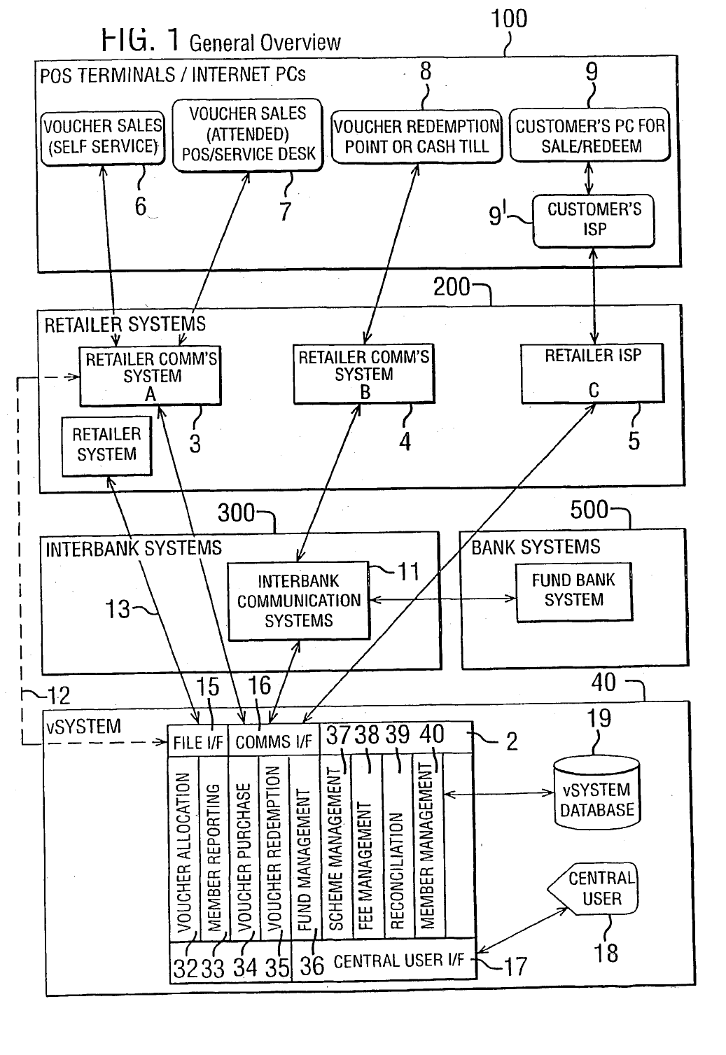

FIG. 1 is a block diagram showing a general over-view of an electronic processor and associated peripheral terminals which are in accordance with an embodiment of the present invention;

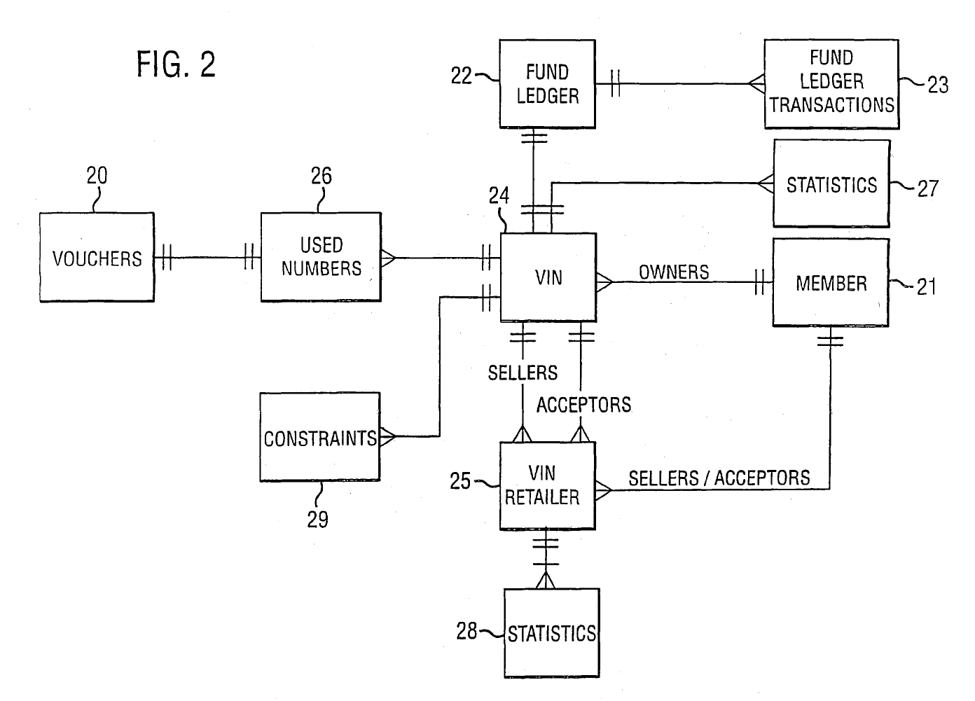

FIG. 2 is a block diagram showing the main data base tables of the electronic processor of FIG. 1;

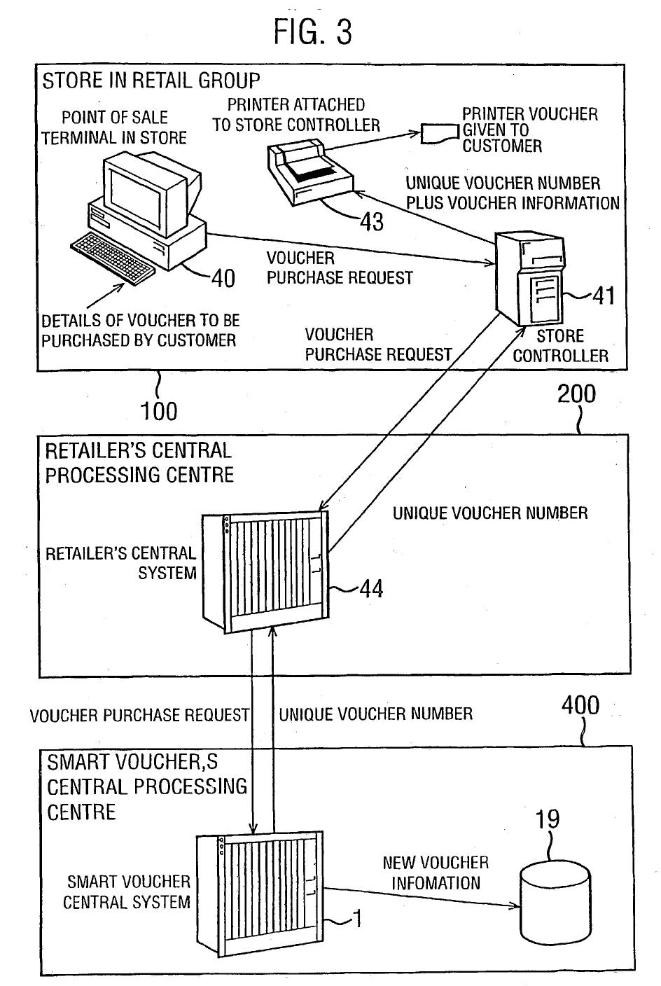

FIG. 3 is a block diagram of hardware for the system of FIG. 1;

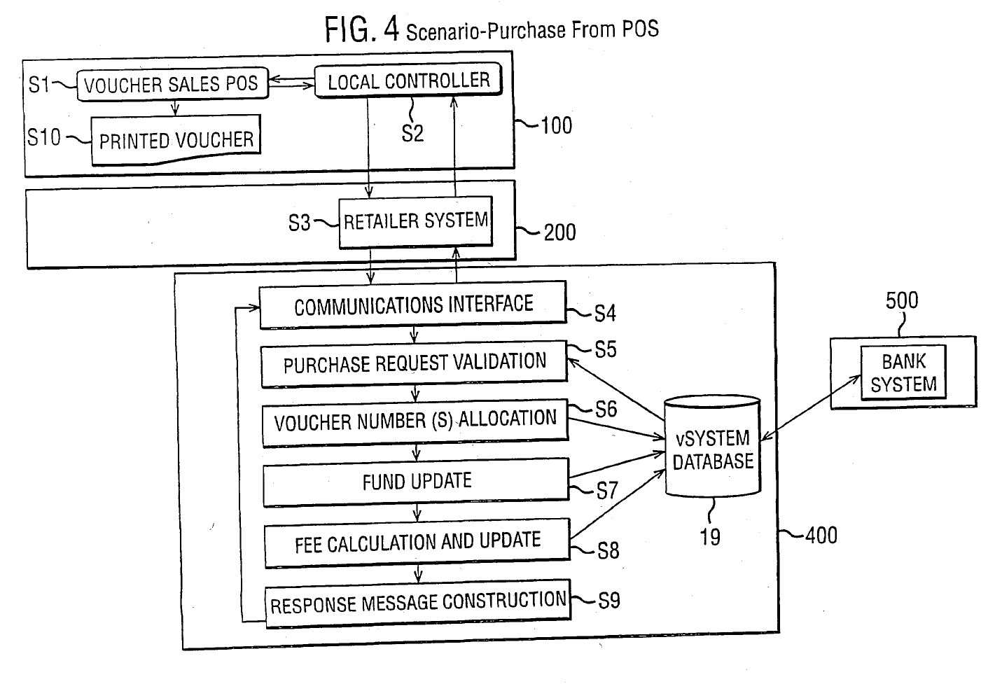

FIG. 4 is a data flow diagram illustrating the purchase of a cash voucher;

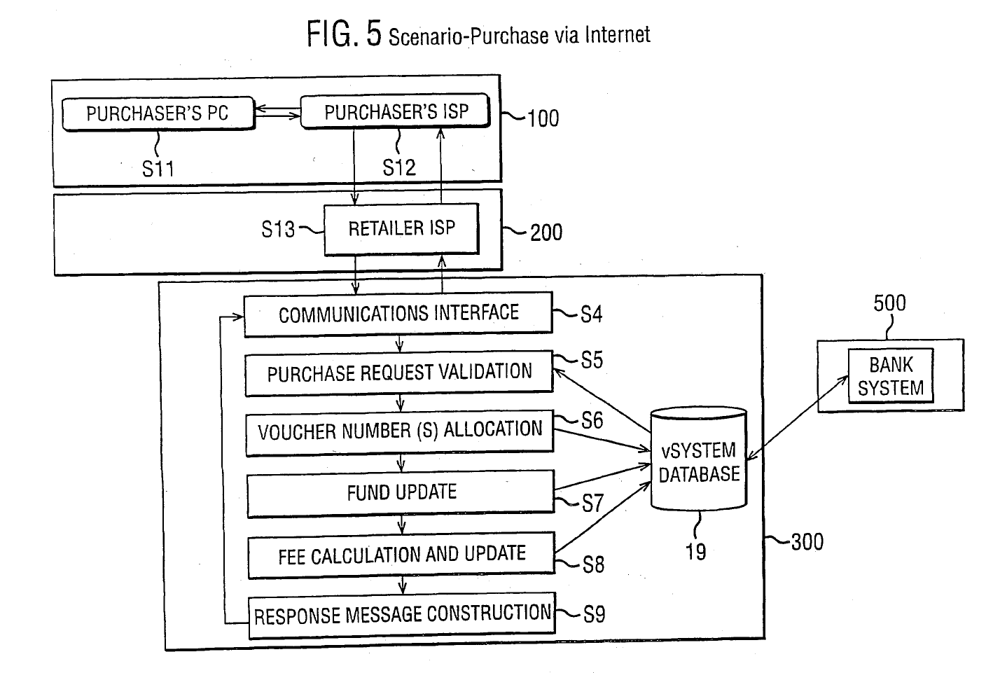

FIG. 5 is view similar to FIG. 4 showing the purchase of a cash voucher via the Internet;

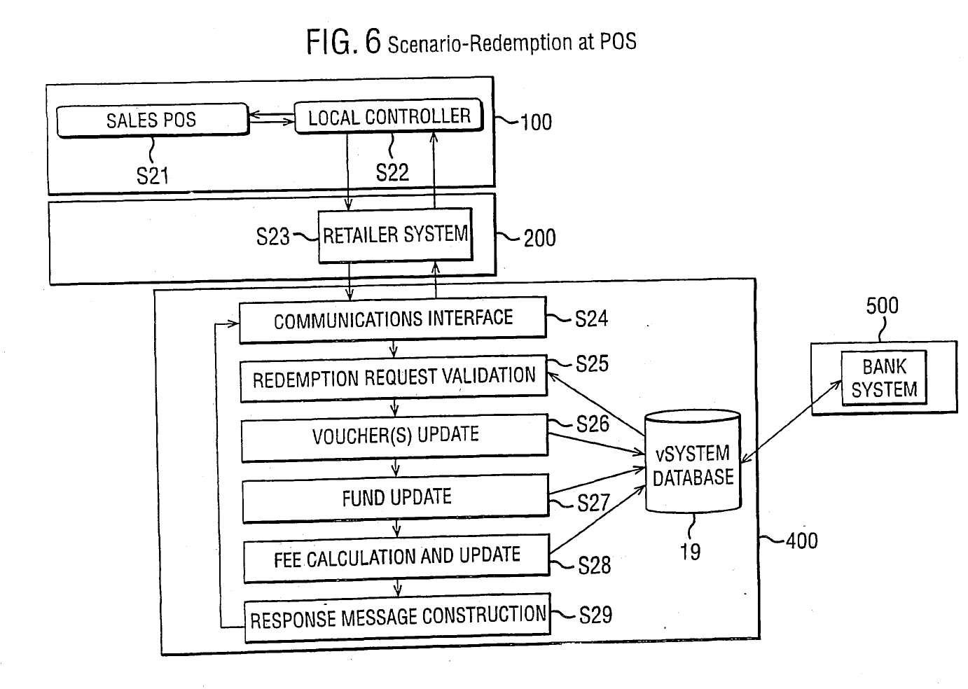

FIG. 6 is a data flow diagram showing the redemption of a cash voucher at a point of sale terminal;

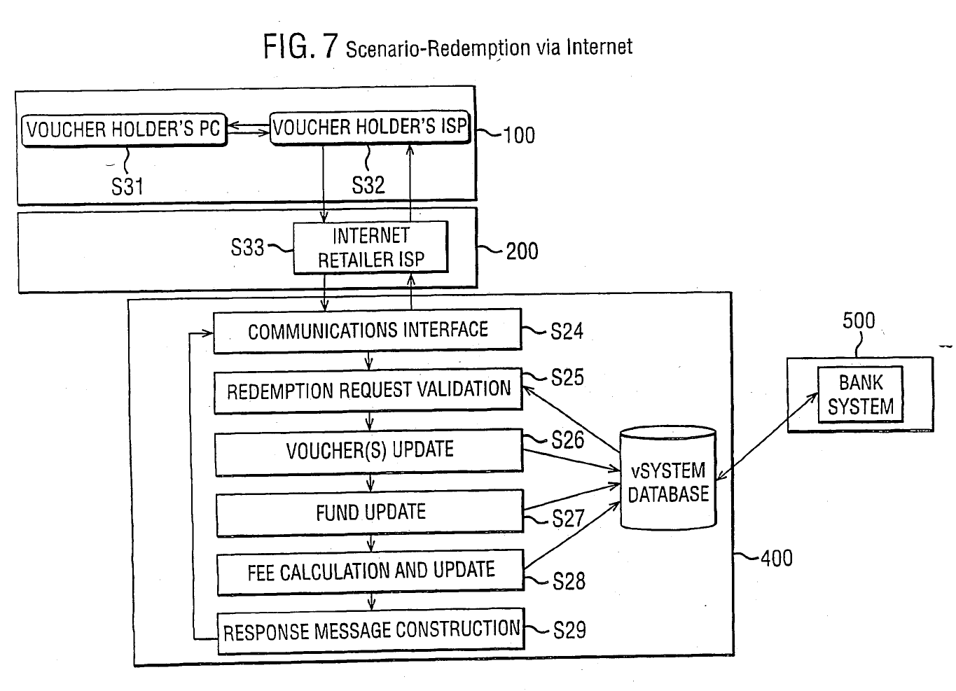

FIG. 7 is a data flow diagram showing the redemption of a cash voucher via the Internet;

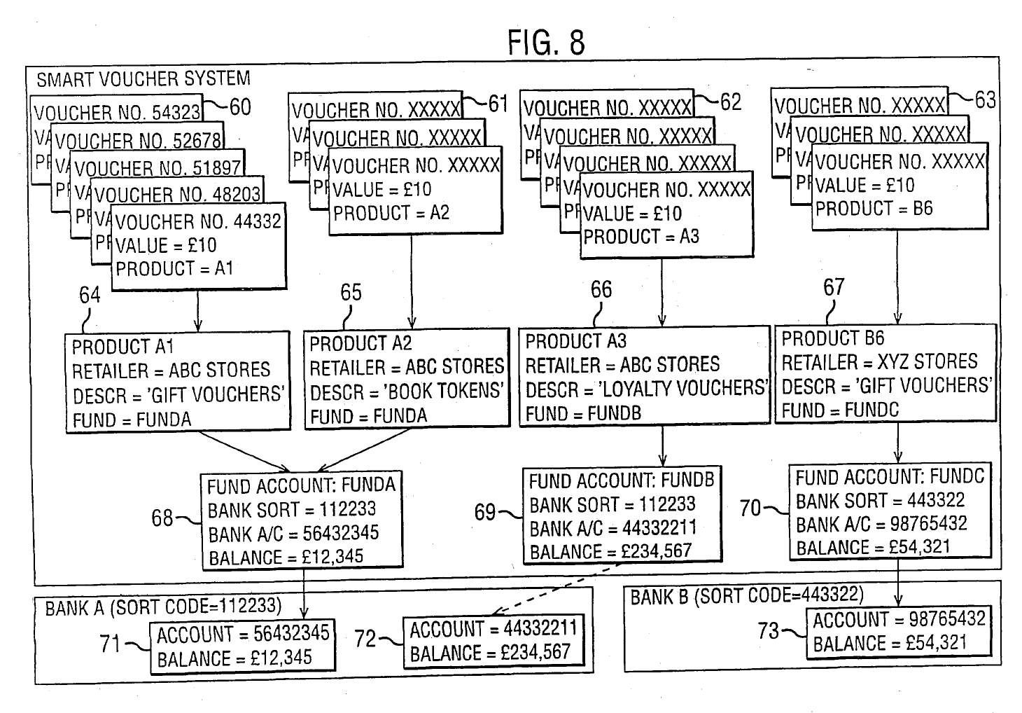

FIG. 8 is a diagram explaining the organisation of fund accounts;

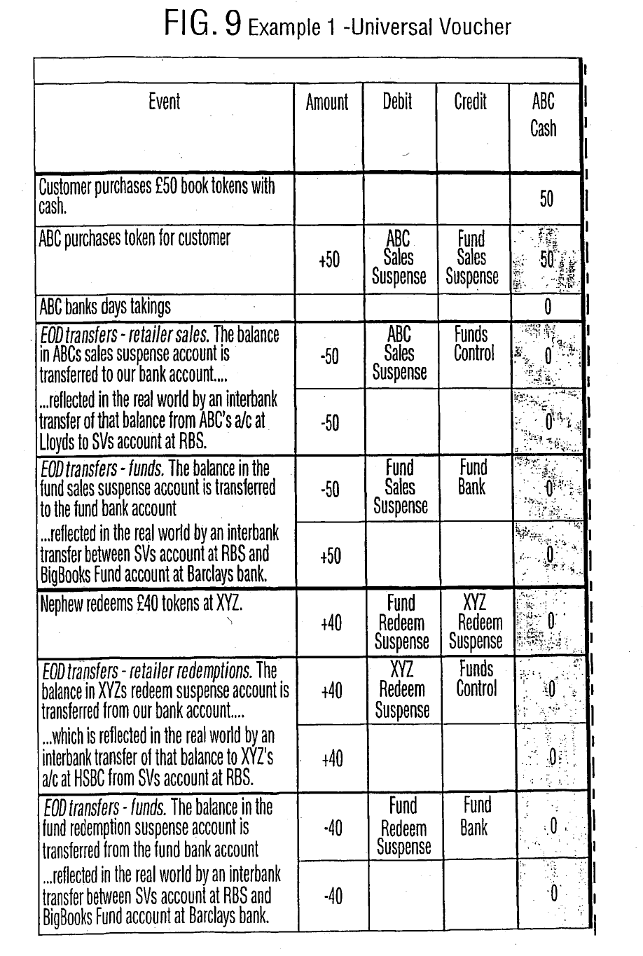

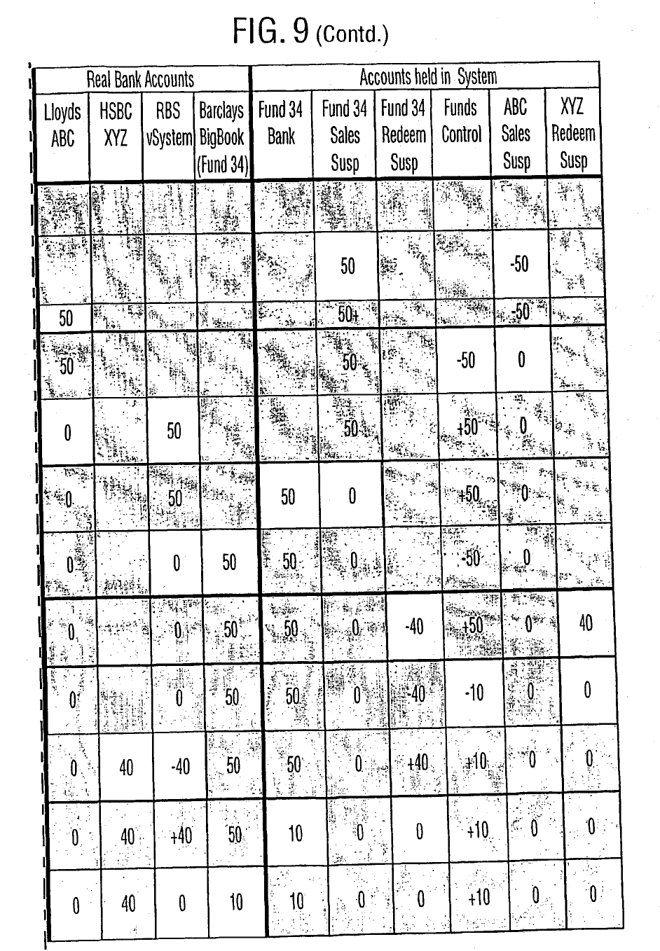

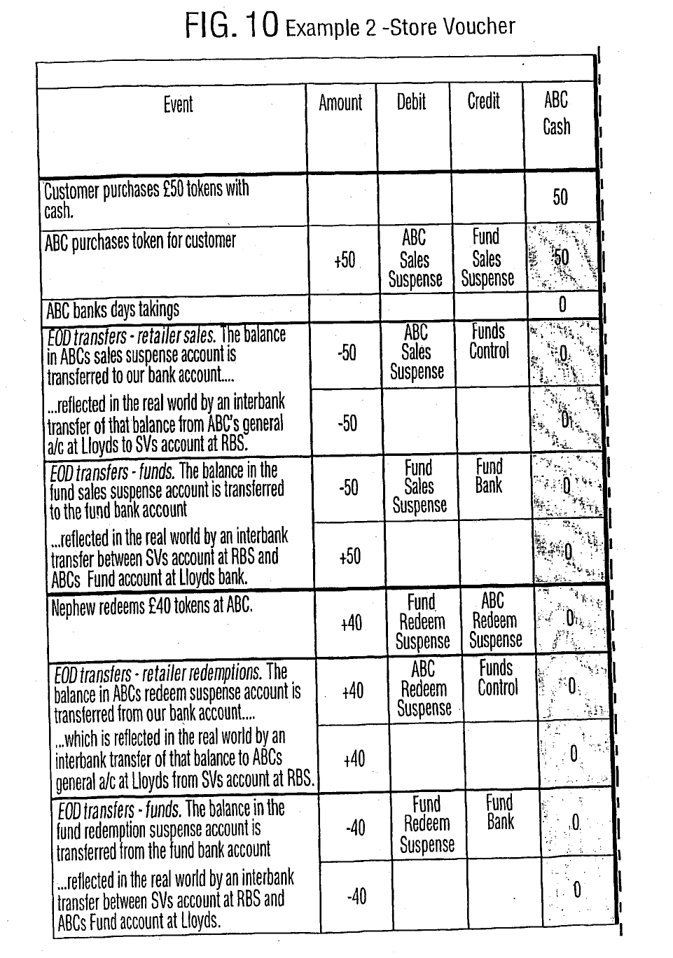

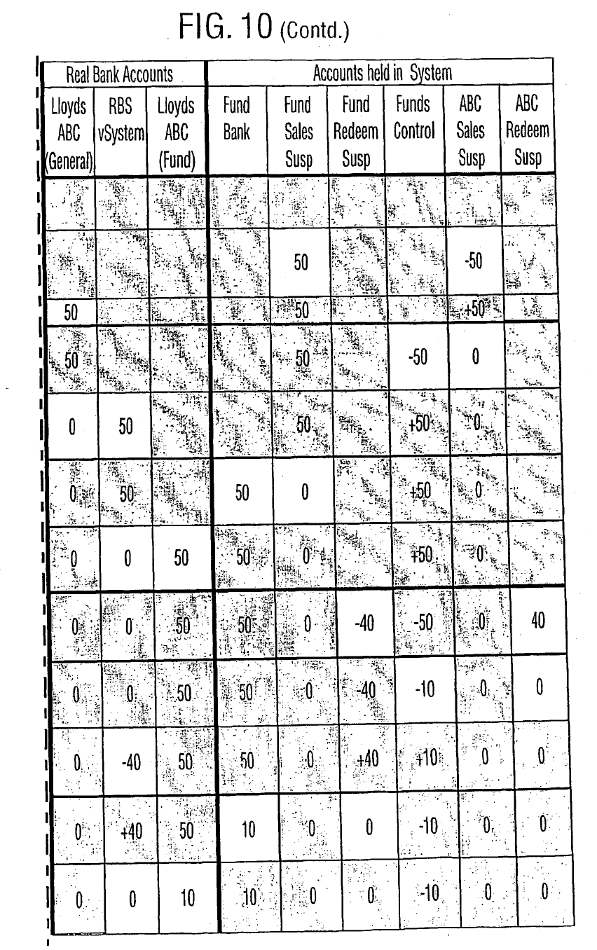

FIGS. 9, 10,11 and 12 are tables illustrating cash movement during example transactions:

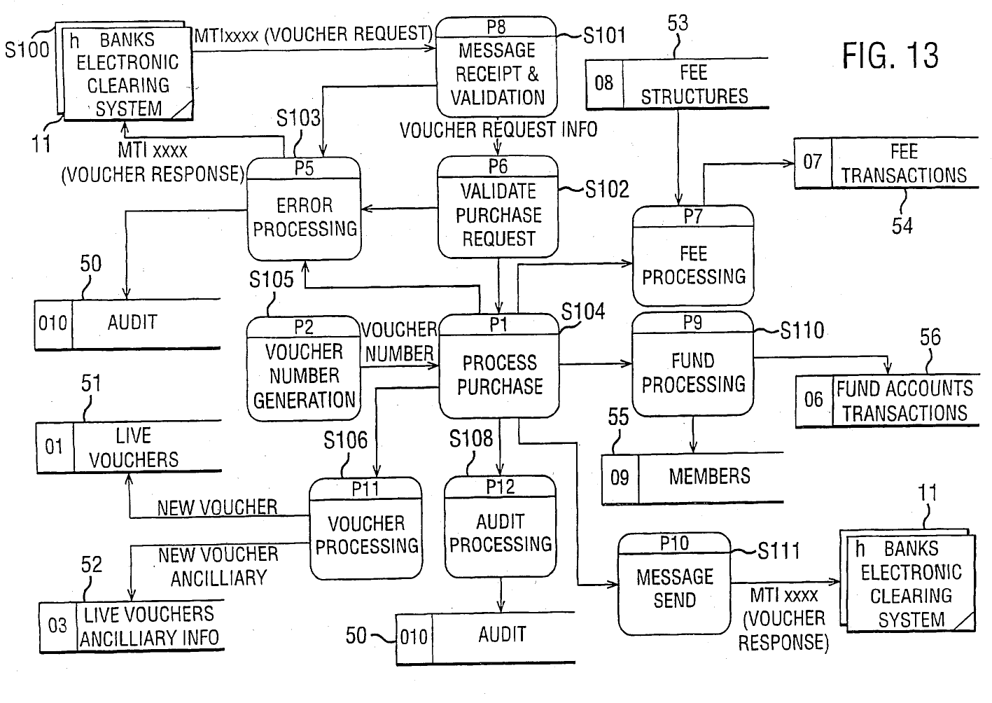

FIG. 13 is a more detailed flow diagram of the purchase of a cash voucher;

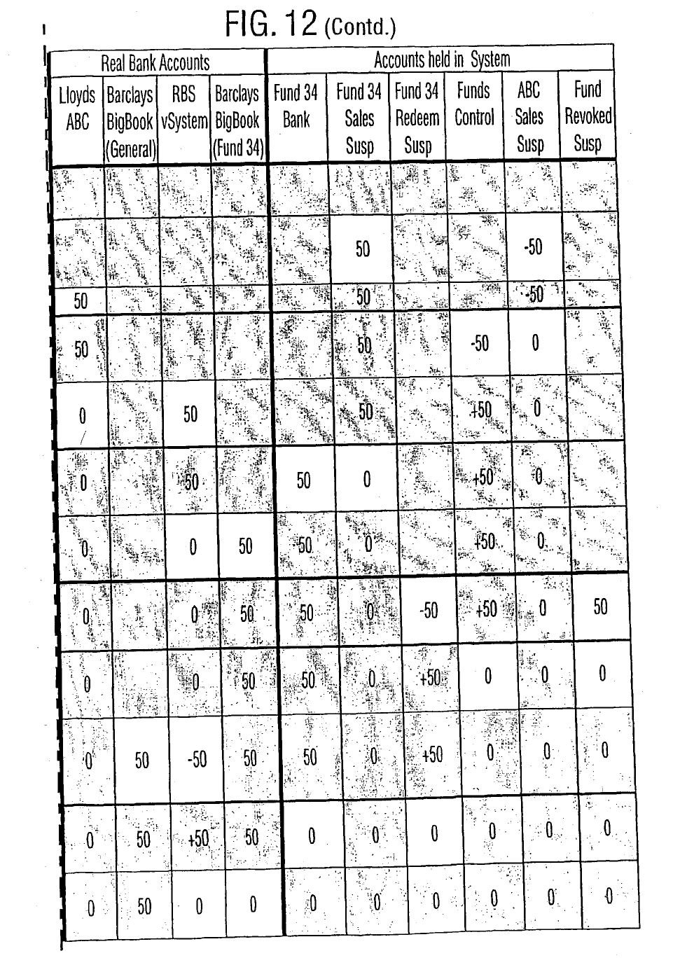

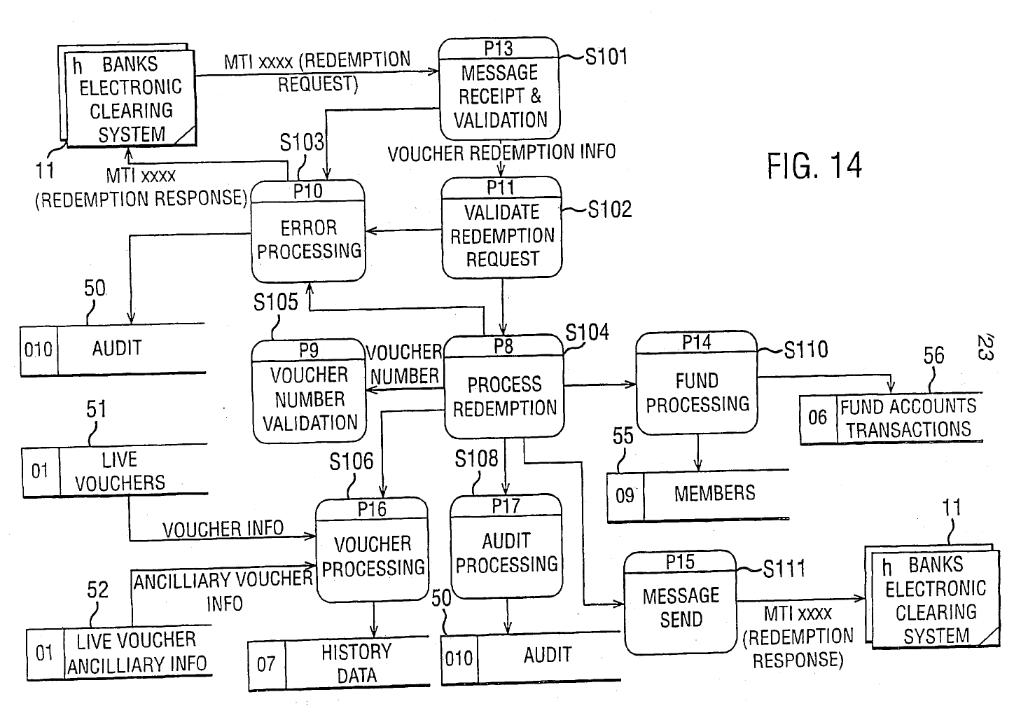

FIG. 14 is a similar diagram to FIG. 12 showing the redemption of a cash voucher;

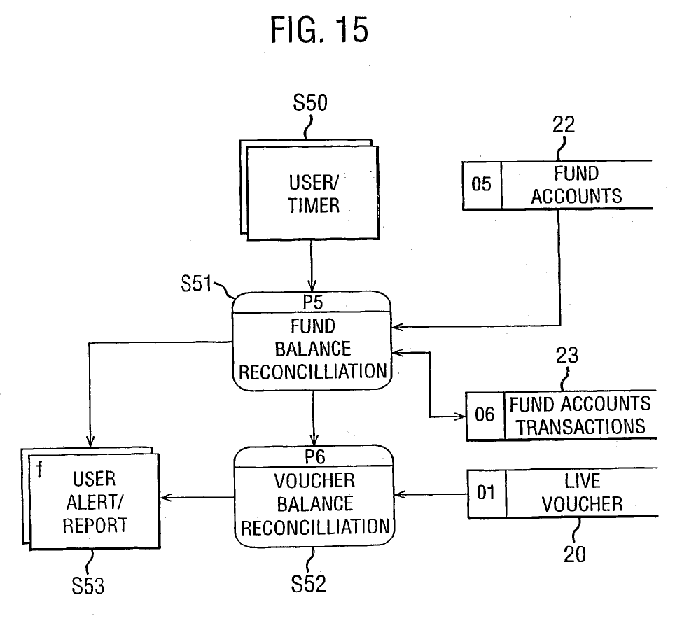

FIG. 15 is a diagram showing reconciliation in the system shown in FIG. 1;

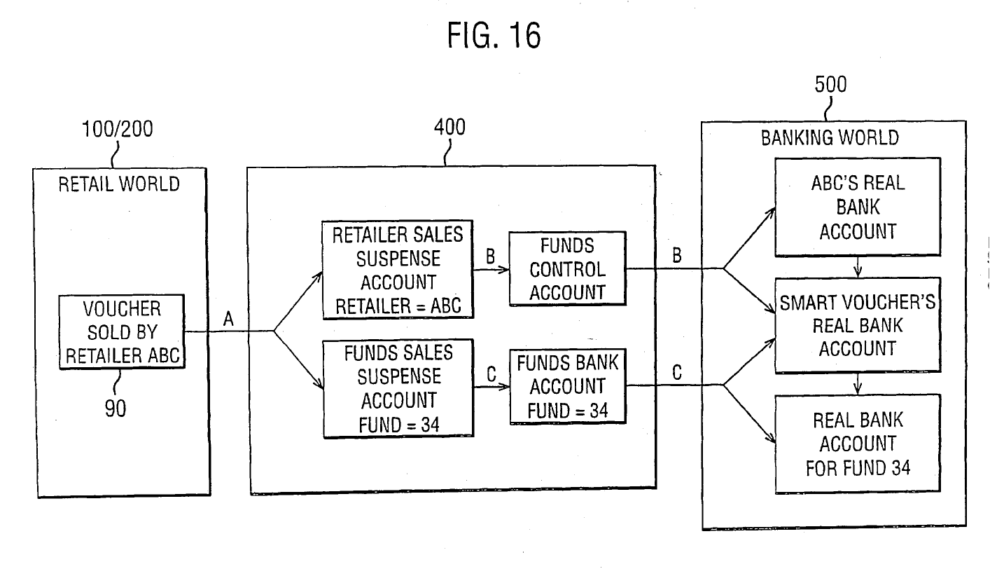

FIG. 16 is a block diagram indicating the relationships between the retailers, the core system and actual banking accounts;

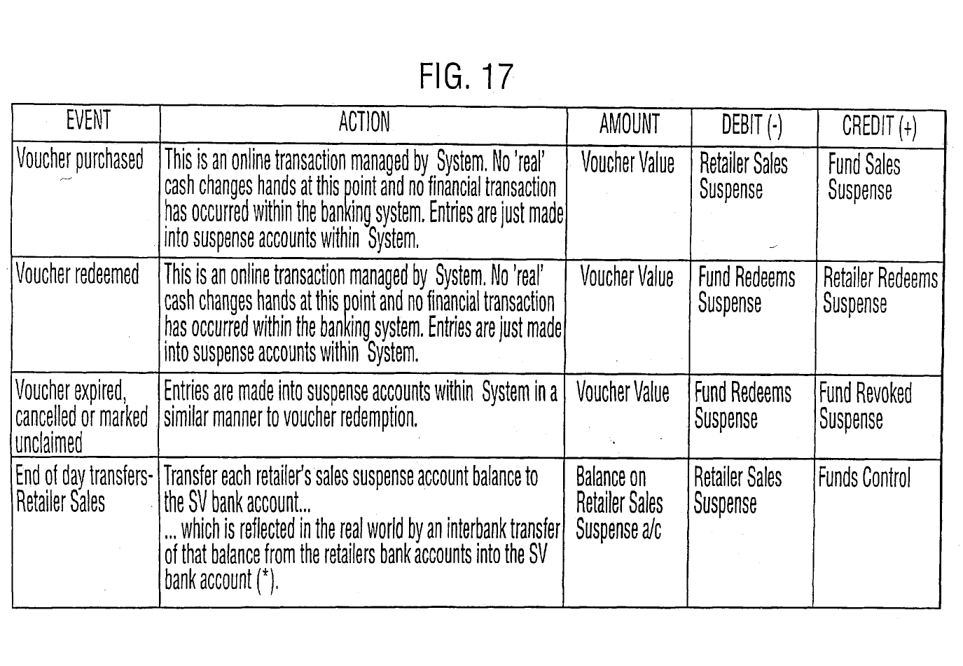

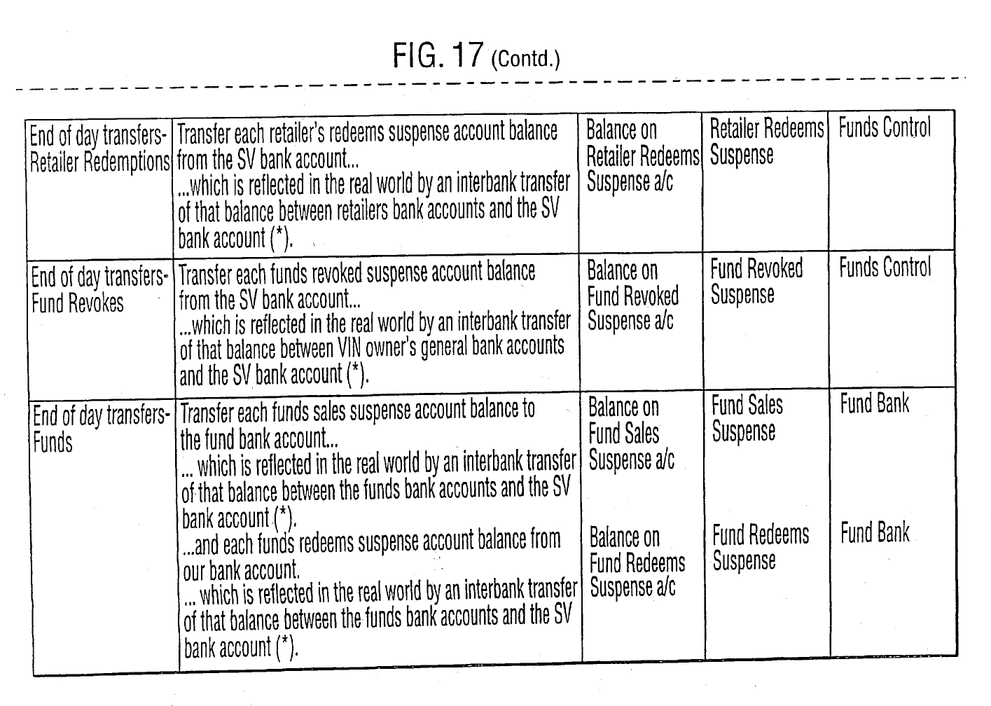

FIG. 17 in a table showing accounts postings; and

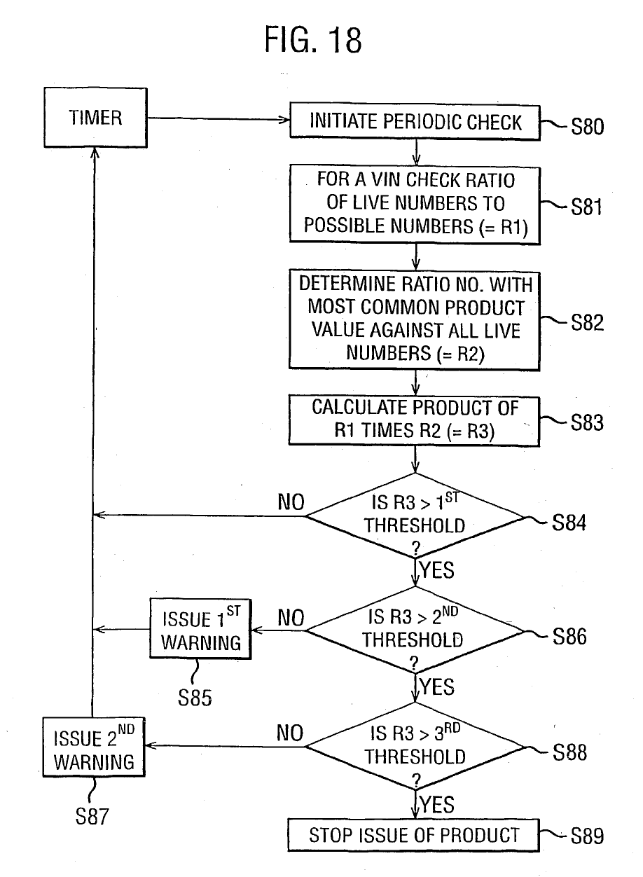

FIG. 18 is a flow chart illustrating a security algorithm.

Referring now to FIG. 1 of the accompanying drawings this shows an electronic transaction system which comprises a voucher processing system 1 having a front end interface 2. The term “cash voucher” is used in the present specification in a special sense. It is to be clearly distinguished from paper vouchers frequently used by retailers for subsequent redemption. Record tokens are well known examples of such paper vouchers as are reward coupons issued by retailers on the basis of volume of purchases by a customer. In the present specification a cash voucher is essentially a computer record stored on a secure master database. The system to be described has several layers of functionality and purely for the purposes of the present description it is assumed that the overall cash voucher handling system involves as participating members three different retailers A, B and C shown respectively at 3, 4 and 5. Again purely for the purposes of the present description it is assumed for the present that the retailers are conventional retailers supplying goods either to personal shoppers or to customers ordering from a distance.

The system shown in FIG. 1 has five layers of functionality indicated separately at 100, 200, 300, 400 and 500.

The first layer of functionality is shown at 100 and comprises the terminals at which customers interact with the overall system.

Thus it will be seen that retailer A has a cash voucher sales terminal 6 which is self-service and a cash voucher sales terminal 7 which is attended. Retailer B has a voucher redemption terminal 8 but retailer C handles sales and redemptions of cash vouchers only over the Internet.

The second layer of functionality 200 represents retail companies with which customers deal via layer 100 by either purchasing cash vouchers or redeeming previously purchased cash vouchers for goods.

In functional layer 100 the self service terminal 6 essentially comprises a manual data arrangement such as a keyboard, a display terminal and a reader for reading credit/debit cards or for validating or accepting cash. It may also include a printer for giving a hard copy of the voucher. FIG. 3 shows an example of such a terminal using a credit/debit card A customer wishing to purchase a cash voucher will carry out a sequence of actions based on his/her PIN and similar to those used to obtain cash from a cash dispenser. The terminal 7 which is attended will also have a manual data output arrangement which will be used by the attendant and additionally can take cash or any other payment medium acceptable to the retailer in exchange for the issuance of a cash voucher. Naturally the attendant will be able to carry out additional verification of the customer identity.

Retailer B shown at 4 has a redemption point 8 at which cash vouchers can be redeemed either for cash or for goods, whilst retailer C, shown at 5, has an Internet based system by means of which a customer can obtain cash vouchers over the Internet. In order to do this the customer must have Internet access and this can soon be provided in a number of different ways such as via any Internet PC or a mobile phone. Typically the user will have a PC 9, with a modem so as to be able to contact the Internet Service Provider (ISP) 5 of retailer C via the users own ISP 91.

It has to be appreciated that these three terminals 6, 7 and 8 are purely exemplary and that there is no necessity whatsoever for a retailer in the second layer 200 to be limited to any one type of terminal. The functions of the terminals in any case are essentially the gathering of voucher purchase or redemption information from the user and performing basic validation. The amount of validation, if any, will depend on the level of intelligence of the data collection terminal if unmanned or the procedures to be followed at a manned terminal. These procedures can be determined by the retailer provided they meet minimum requirements of the operator of the system. The commercial relationship between retailers and the voucher system will be discussed in greater detail later on in this specification.

In the second layer 200 of the general system normal functions carried out by the various retailers in the course of their normal trade will not be discussed in detail. However in this second layer the new data entered at the terminals in layer 100 is processed by the retailers for communication to the interface 2 of the core system 1 in functional layer 400.

The retailers just described are all “members” of the cash voucher system. Thus they can own their own voucher scheme and in such a case might hold a bank account for the funds involved in the operation of the cash voucher system. On the other hand members could have the system managed on their own behalf. One example would be a universal book voucher scheme which would have an owner such as Big Book Tokens Ltd. The cash vouchers could then be purchased from any retailer and redeemed with appropriate conditions from any accepting retailer.

In one embodiment of the invention this processing in functional layer 200 essentially consists of a second level of validation which will be described in greater detail hereinafter and then encryption of the data into a format suitable for secure transmission to the layer 400. This transmission can either be by the well known Interbank Communication System as shown at 11 in functional layer 300 or alternatively can be made direct from the retailer. Even in the second case the format of the encrypted data can be the standard MTIxxxx format used in the Interbank Communication System. Additionally a retailer can at either of layers 100 or 200 introduce constraints on the redemption of vouchers. These constraints are of considerable importance and will be discussed in detail later on in this specification.

The other essential function of layer 200 is the decryption of messages received from layer 400.

The dotted line 12 shown linking layers 200 and 400 shows an optional linkage between a retailer system in layer 200 with the layer 400 which need not use the format of whatever communication protocol is employed. This link 12 can be used to transfer non-urgent data such as additional retailer held data concerning cash voucher and management information for the retailers' own analysis and records. Thus this link 12 does not necessitate the encryption used when details of cash vouchers are being transmitted between the functional layers.

Additional link 13 is shown linking a retailer 14 in layer 200 to the core system 1 located in layer 400. This link 14 can transfer bulk allocation files containing details of vouchers to be allocated in bulk and as such can be used for allocating cash vouchers perhaps as loyalty rewards or for promotional schemes.

Turning now to the core system 1 this has an interface 2 which has a section 15 for receiving messages via links 12 and 13 and a section 16 dedicated to receiving and transmitting messages in a standard format over the Interbank Communication System 11 or direct from or to retailers as shown by the path of unmarked links from 3 and 5. The other main interface of the central processor 1 is shown at 17 and is the interface used by the system operator 18, that is the organisation managing the overall system on behalf of the participating members.

One of the fundamental components of the core system 1 is a database 19 housing a plurality of data base tables used in the processing of cash vouchers. The main tables of data base 19 are shown in FIG. 2 of the accompanying drawings and includes a main table 20 holding data of live and redeemed cash vouchers. This table 20 is in the present embodiment divided into sections including a live voucher table which holds details of all cash vouchers which have not been redeemed, and a historical voucher table which may hold details of all cash vouchers which have been redeemed. The term “may” is used as it may be necessary to archive historic voucher details in an archive section after a predetermined time has elapsed. Additionally the table 20 will hold details of unclaimed vouchers. Table 21 of the data base 19 holds members details, namely all those members such as retailers A, B and C which are participating with the cash voucher processing system managed by the system operator. Thus members are either retailers or owners of individual schemes.

Table 22 is a Fund Ledger table and holds details of the Funds which provide the backing of the cash vouchers listed in the live voucher table whilst table 23 holds details of Fund Ledger transactions which occur when vouchers are issued or redeemed. Each fund Ledger effectively shadows a physical bank account held at a financial institution indicated at functional layer 500. The manner in which funds are organised and the way in which they interact with actual bank accounts will be described in greater detail later.

Associated with the Funds Ledger table 22 is a Voucher Issuer table 24. This table sets out the conditions under which a cash voucher is issued by an Issuer. At this point it is essential to clarify possible relationships between the operators of the core system and those members which participate in the actual process in which customers request and redeem cash vouchers. The members can belong to a range of different categories.

A first category is that of a Voucher Issuer sometimes referred to as owner. A Voucher Issuer is a body contracted to the operators of the system and which defines a particular class of voucher by setting constraints on how the vouchers can be used.

A second category is composed of those members authorised to sell vouchers on behalf of a Voucher Issuer, and a third category contains those members authorised to redeem vouchers. It is of course entirely possible for a Voucher Issuer to belong to one or both of the other two categories. Each cash voucher number generated by the system includes a Voucher Issuer Number (VIN). This VIN identifies the Voucher Issuer. As mentioned, a voucher Issuer has the ability to define constraints on the use of a cash voucher. In the present embodiment this is achieved by means of additional coding in the cash voucher number so that the combination of the VIN and this additional coding defines the condition of use of the voucher. There is no need in normal operation for the core system to know the constraint codes which are the province of the Voucher Issuer and will be transmitted to the core system with a request for the generation of a voucher when one has been purchased. A particular combination of VIN and the constraint code is considered to define a particular product. The manner in which they are generated will be described hereinafter. Thus data held in the Voucher Issuer table 24 includes for example the Fund accounts associated with a voucher, minimum and maximum voucher values, the start date from which the voucher can be redeemed, the duration of the voucher and commission fees relating to the sale and/or redemption of any vouchers. Unless a voucher has an expiry date it would have to remain permanently on the live voucher table of the data base. Duration is expressed in days, months or years and is calculated at the time of purchase from the voucher start date. The manner in which the funds accounts are organised will be described in greater detail hereinafter.

More detailed examples of the kind of constraints which can be set by a Voucher Issuer and which can be associated with a cash voucher are given in the following passage. As already explained these constraints are normally set by the relevant member of the scheme when the cash voucher request is generated in layer 100 or layer 200. Firstly a constraint placed on the purchase or redemption of a cash voucher can be based on a chain of stores. Thus constraints could be placed on a cash voucher so that it can be purchased at only some of a group of retailers, and redeemed at either all of the group or only some of the retailers constituting the group. The selling stores and the redeeming stores need not be the same.

Secondly with or without the above constraints a cash voucher could be limited to redemption for the purchase of certain classes of goods.

Thirdly a voucher could be purchased or redeemed at a range of different retailers including the constraints of the first two examples.

As already discussed the voucher might be a “universal” one in that it can be redeemed at any one of a number of retailers but purchased from a separate organisation only linked to the retailers in the sense that it provides a service for them. In any case a cash voucher might have a geographical constraint so that it can only be redeemed in a specific area which might be a town, city, county or country.

At this point it is worth emphasising that the term “retailers” as used in the specification is not limited to retail stores but in fact can include any provider of cash vouchers including Government agencies such as the DHSS, banks and Post Offices.

Whilst it is likely that most retailers will make use of the flexibility to define and manage their own constraint codes (products) the VIN Group operator may also choose to provide this functionality to those retailers who require a relatively low level of constraint management. In this case the VIN Group operator will set and manage the constraint codes using the already mentioned constraint table.

In order to generate the Voucher Issuer table 24, the member table 21 holds details of those stores that can be used in purchasing or redeeming vouchers. In this context it must be appreciated that a major retailer will have many outlets or stores so that a voucher purchased at one store of a retailer does not have to be valid for all the stores belonging to that retailer. Thus this feature is also under the control of the Voucher Issuer. The member's table 21 holds for each member a unique member identifier number so that a voucher can only be redeemed by an identified number.

Table 25 is dedicated to the scheme retailers and lists all the details as to which retailers can sell or redeem cash vouchers.

It is possible for constraints to be placed on the use of a cash voucher outside the use of the Voucher Issuer table 24. These constraints, if managed by the core system will be held in a separate constraint table 29.

In addition to the main tables just described the main data base 19 holds a number of auxiliary tables which will be briefly described. Firstly in the interest of security used numbers are held in a table 26. In addition tables 27 and 28 hold statistical data relating to voucher usage which can be used by management.

It will be appreciated that the data stored on the data base will be very detailed with regard to all the aspects of voucher usage such as amounts, geographical distribution of sales and redemptions the media used. Thus members can easily extract business profiles for use in tuning their publicity, generation of new products, and useful management statistics. No current manual or semi automated system can achieve this.

Additionally the main data base can contain a table which holds details of all vouchers which have expired. The expired vouchers are moved to this table a user defined period after expiry and the structure of this table is the same as that used for live cash vouchers.

Whilst the present embodiment apparently discloses a single data base at a single location it is of course possible for the various areas and tables of the data base to be distributed over different geographical locations.

Referring again to FIG. 1 of the drawings it will be seen that central core processor 1 is also sub-divided into a number of functional areas.

The overall functionality of the core processor 1 includes the rendering and processing of voucher purchase and redemption, the bulk allocation of vouchers and advice of the allocated voucher numbers to recipients, and the management of voucher funds.

Thus associated with the two communication lines 12 and 13 is a functional area 32 dealing with the bulk allocation of voucher numbers and a functional area 33 dealing with non-urgent data such as management information for participants. These areas communicate via the interface section 15.

The other functional areas of the core processor 1 communicate, in the present embodiment, with functional layers 100, 200 and 300 via the interface section 16.

These are functional areas 34, 35 and 36 which respectively relate to voucher purchase, voucher redemption and Voucher Issuer management.

The most important of the remaining functional areas of the processor 1 are area 37 which deals with fund management, area 38, which deals with fee management, area 39 which deals with reconciliation and area 40 which deals with member management.

Having given an overview of an embodiment of the electronic processing system there will now be described purely by way of example the hardware components that make up the core processor 1 and interface 2.

Referring now to FIG. 3 of the accompanying drawings this shows hardware which can be used in the general system shown in FIG. 1. The functional layers described in FIG. 1 are also present in FIG. 3 and it will be seen that layer 300, which is optional, has been omitted. Layer 100 includes an electronic point of sale terminal shown at 40 by means of which an assistant can enter details of a cash voucher to be purchased by a customer, whilst 41 indicates a processor located at the actual store where voucher transactions takes place.

Also shown in layer 100 is a printer 43 for printing an issued cash voucher number. The printer may also be capable of printing a bar code representing the voucher number to enable quicker reading of the voucher at a till equipped with a bar code reader when a voucher is to be redeemed.

The retailers central processing centre is in layer 200 shown at 44 and the central processor 1 is shown in layer 400 along with the main data base 19. It is expected that the data volumes and transaction rates of the voucher operation will require substantial computer storage and processing power. The system also needs to have high availability, resilience and security. To satisfy all these requirements it is expected to run the voucher system on an IBM mainframe using IBM's (RTM) operating system (MVS), data base (DB2) and access control and security software (RACF) or on a comparable system.

Having given an overview and a description of suitable hardware the operation of the system shown in FIG. 1 will now be described in greater detail. Reference has already been made to the concept of cash vouchers and it is to be understood that these are entirely different from paper-based vouchers in that they are “virtual”, that is they exist in the form of data. In essence the cash vouchers merely exist as computer record stored in the secure master data base 19 which can be accessed in real time internationally by any participating member such as a high street retailer or a web-based retailer. The computer record is identified by a unique code and as already described contains details which identify the location of the computer record and the factors which define the way in which the voucher can be redeemed. Thus the value of each voucher is stored on a bank account which is dedicated only to funds associated with vouchers. Accordingly when a purchaser purchases a voucher using functional layer 100 the purchaser is provided with a unique code. In turn the unique code enables the system to determine the value, expiry date if any, and constraints as described with reference to the Voucher Issuer table of FIG. 2 or normally set by the VIN owner. Thus the purchaser of a cash voucher is given data at the time of the sale concerning the constraints attached to the voucher including the expiry date.

Accordingly, the unique code relating to a purchased voucher is of considerable importance. Thus it should not be possible for the possessor of a valid voucher number to be able to make an educated guess at another valid number and to use it. For example, in a scenario given purely by way of example, if voucher numbers were allocated sequentially with a single check digit then a purchaser of vouchers with the numbers 896657, 896662 and 896670 could reasonably guess that 89668x is a valid number. Only a maximum of ten attempts are needed to determine the value of X.

Thus in the present embodiment the voucher number is a unique 19 digit number. The length is chosen to be compatible with the maximum size currently used in the credit/debit card industry, i.e. it conforms to ISO 8583. The first six digits constitutes the IIN (Identification Number) which has been allocated to the systems operator. The coded number can be divided in the manner shown in Table A.

TABLE A

| Locations 1-6 | Locations 7-10 | Locations 11-18 | Location 19 |
|---|---|---|---|
| IIN | VIN/Constraint | Voucher identifier | Check digit |
| (6 digits) | Code (4 digits) | (8 digits) | (1 digit) |
| standard for | Set by seller of | Created randomly | Calculated |
| Database | voucher | by operator system | from rest by |
| Some VIN | | | operator |
| owners may | | | system based |
| have their own | | | upon standard |
| IIN | | | algorithm |

It will thus be seen that it is locations 7-10 of the voucher number which enables a participating member of the system to set constraints such as those described earlier in the specification. This division of the coded number can be altered. For example the VIN constraint code in particular need not be 4 digits and could for example be 3.

Additionally the generation of a voucher number involves an algorithm which ensures that numbers are not repeated. In the present embodiment the following logic will be used to allocate a voucher number.

Obtain a random number.

Check that the number is not on the ‘do not use’ list. If it is then increment the random number and retry. After a defined number of unsuccessful skips, obtain another random number. After a defined number of unsuccessful random numbers, reseed the random number generator and try again. After a defined number of unsuccessful re-seedings, give up the allocation attempt and fail the transaction—failure at this point when the preferred maximum allocation has not been reached indicates a poor choice of random number generator. Statistics should be retained on the successful/unsuccessful attempts and these should be reported regularly to alert management to potential problems.

Check that the number has not already been allocated for the required product. If it has, then retry as described above.

In the unlikely situation that more than the ‘absolute maximum live allocation’ or ‘absolute maximum allocation’ of all possible numbers are already allocated for a particular product, then the voucher cannot be issued.

An algorithm for checking allocated numbers and issuing warnings will be discussed in greater detail hereinafter.

Given the described voucher number structure and anticipated volumes, this situation should only ever occur after several years of warnings that the ‘preferred maximum allocation’ limit has been reached, followed by more warnings that the ‘absolute maximum allocation’ level is approaching. If acted upon, the warnings should give sufficient time to investigate and propose alternatives, such as start another product number for the ‘same’ product.

An important feature implemented by the system is that in order to reduce the likelihood of invalid or fraudulent transactions being introduced to the communications network, messages for each retailer will include a sequence number (a different sequence for each retailer category and for inbound and outbound messages) which will be verified as the next in sequence by the receiving system.

As an additional check against fraudulent contact the system holds in the members table 21 data identifying, for example, the members network address or telephone number so that the system can check both the members identifier number and the contact source before validating the redemption of a voucher.

An already mentioned additional security feature of the system is to monitor, for each product, the number of unredeemed (“live”) vouchers as a percentage of the total possible numbers and also the profile of the live voucher values to identify the most common value. By monitoring centrally it will enable the system operators to evaluate the risk of a voucher number, value and expiry date being guessed. The risk increases as the percentage of live vouchers rises and there is a high proportion of vouchers with the same value. When the risk for a particular product rises to a pre-set threshold the Voucher Issuer will be warned. If a second threshold is breached a stronger warning will be issued for example asking for a new product to be introduced. If a third threshold is breached then the issue of vouchers for that particular combination of VIN/constraint code will be stopped. In FIG. 18 a timer 99 initiates step S80 which is the start of a periodic security check. Thus at step 81 the processor checks for a VIN the ratio of the number of live vouchers against the number of possible voucher numbers. At step S82 it is determined from the profile of all of the live vouchers which is the most common product. Step S83 calculates the ratio of live numbers to possible numbers of the most popular product and step S84 determines if this ratio is above a first threshold. If the answer is no nothing further happens until the checking sequence is again initiated by the timer or by a management decision. On the other hand if the answer to step S84 is yes a first warning is issued at step S85. A second decision is made at step S86 as to whether or not the ratio calculated at step S83 is above a second threshold and again if the answer is no no further steps are taken. However if the answer is yes a second, stronger warning is issued at step S87. Finally step S88 determines whether or not the calculated ratio is above a third threshold and if the answer to this is yes then at step S89 issuing of that particular product is stopped.

Turning now to FIG. 4 of the accompanying drawings this shows a flow chart box the basic procedures which are followed when a voucher is purchased. It is assumed that the point of purchase is a high street retailer similar to retailer A of FIG. 1 and having a sales terminal 6. Thus a voucher can be purchased along with any other goods available at the store or could be earned as a reward for the amount of purchases just made by the customer.

In FIG. 4 step S1 shows that at the sales terminal a sales assistant takes details of the voucher(s) required together with any locally determined product constraints together with any other confirmation and issues a voucher request to a local controller. In step S2 the local controller transmits the request to the retailer system in functional layer 200.

The retailer system at step S3 has the main functions of carrying out additional validation procedures, determining the VIN/constraint code to go in the request, encrypting the voucher request in a suitable manner, and transmitting the encrypted voucher request to function layer 400.

In the present embodiment the retailer system issues a voucher purchase request using the APACS standard 60. This is a standard which allows for private use messages and which defines various data elements and which data elements are mandatory or conditional for each type of message. The APACS standard 60 is the standard used in the Interbank communication system 11 in functional layer 300 of FIG. 1

It is to be clearly understood that use of the APACS standard 60 is not fundamental to the basic inventive concept as the use of this standard is not essential to the implementation of the present invention. A user in the United States, for example, might utilise a different format.

The Interbank Communication System 11 is not shown in FIG. 4, or in the similar FIGS. 5, 6 and 7. This is because in implementing the present invention the Interbank Communication System is only used as an already available and secure conduit for messages.

Thus the encrypted messages can either be sent via the Interbank Communication System or can be sent direct to section 16 of interface 2.

The interface has a form of validation in that it ensures that the request is in the correct format and from a known source. In step S4 the encrypted voucher request is received by the interface 2 and forwarded for purchase request validation in step S5. The purchase request validation procedure includes checking that the retailers supplied 4 digit VIN/constraint code is for a valid voucher scheme. Additionally, the other criteria of the requested voucher have to conform to the attributes for that particular VIN. In step S6 a voucher number is allocated to each voucher request if no errors have been detected in the validation procedure. The allocation of a voucher number brings about consequential updates to the fund tables which have already been described and this is done in step S7. At step S8 information concerning the voucher is passed to the management system (not shown) for calculating fees charged by the operator of the system, and at step S9 a response message is returned to section 16 of the communications interface 2.

The calculation of management fees is incidental to the invention concept and can be done on a per-voucher basis or purchase and possibly also on redemption. On the other hand they may be calculated at predetermined intervals on the bulk value of purchased or redeemed vouchers.

If during the preceding processing the voucher request was not validated the response, again in APACs standards 60 format, is negative. In any case the communications interface informs the retailer system of the result and the retailer system in turn informs the local controller of the original terminal. In this example the terminal issues a printed voucher bearing the allocated voucher number. At this point the printer can add a bar code to the value identifying the unique voucher number.

The retailer has the option to print information on the issuance of a voucher. This information can be the voucher number only or the extra descriptive information such as the value, the expiry date and any other conditions of use, onto paper printed to their own choice eg. plain, branded or a gift card. The number can be printed as a bar code to assist redeeming retailers to quickly process the voucher and manage any product constraints identified by the number.

It will be appreciated that the preceding description has been given from the perspective of a customer being present at an attended terminal.

As shown in FIG. 1 of the accompanying drawings this is not the only possible scenario. Functional layer 100 of FIG. 1 includes the possibility of purchasing cash vouchers over the Internet. In this case the retailer system will have to carry out validation on the customer details as provided over the Internet before issuing a voucher request for transmission functional layer 400. This is the procedure shown in the flow diagram of FIG. 5.

Referring now to FIG. 5 a purchaser issues a voucher purchase request using in the present embodiment a PC. Naturally other methods of access in the Internet can be used such as appropriately enabled cellular phones or direct television links. In steps S11 and S12 the purchaser connects to the Internet using his ISP and accesses the retailers web site at step S13 using the retailers ISP. The purchaser then completes a purchase form on the retailers web site for a selected voucher issuer. For validation purposes the minimum information provided by the purchaser would be the type of voucher required, the amount of the voucher and debit/credit card details for payment. Additional information may be requested and given at the option of the customer in order to provide extra customer services and/or marketing information. Thereafter the request path is identical to that of FIG. 5 so the steps have been given the same references and will not be described again. As in the previous figure the Interbank Communication System could be used as a secure path. Again as in the previous figure the communications interface returns an appropriate message but in this case the message is returned to the retailer ISP in return. In return step S13 the retailer's ISP informs the purchasers ISP(of the result of the voucher purchase request and in the case of a successful request a voucher number with its value and an expiry date is given to the purchaser.

FIG. 6 of the accompanying drawings returns to the scenario of the attended terminal 7 of retailer A which deals with the redemption of a voucher. It will be seen that the flow of data in this figure is very similar to the of FIGS. 4 and 5.

Thus at step S21 the customer presents the sales assistant with the voucher number, the voucher value and the voucher expiry date. It is not essential that the customer provides an actual voucher as printed in step S10 FIG. 4. It will also be appreciated that the provision of the expiry date is merely an additional security feature not essential to the inventive concept. The voucher can be for part payment of goods with the remainder of the payment being made by cash, cheque/debit card or it can be for the totality of the goods purchased. In fact it is possible to arrange the system so that a purchaser with a voucher worth more than the required goods has a new voucher given for the balance. Naturally if the particular store where the voucher is being redeemed is not also a seller of vouchers this may not be possible. This feature is not available on any other voucher scheme. In response to the voucher number and expiry date the sales assistant (local controller) informs the retailer system of the purchase request at step S22. The retailer assistant and layer 200 will normally have to carry out validation procedures on the request because as already described with regard to the generation of the voucher it may contain details of constraints on its redemption set by the voucher issuer or by the retailer concerned.

If validated, where validation is necessary, the retailer system initiates a payment request and in the present embodiment constructs an MTIxxxx purchase request. The request is sent to the communications interface of layer 400 at step S24 and validation is carried out at step S25. A valid request causes updating of the voucher table 20 of the main data base 19 at step S26 and of the fund ledger 22 at step S27. At step S28 fee information is transferred to a fee generation system so that the fees due to the system operator can be calculated. The same fee considerations apply as described with regard to FIG. 4. Finally at step S29 the response message is generated in the same format as before and sent via the communications interface to the retailer system. The response message can of course be negative in that original request was invalid. Example rejection messages might be “invalid number”, “scheme not valid for this retailer”, “wrong value”, “voucher not in date”, “voucher already redeemed” and “transmission error”. The response is transmitted in reverse step 23 to the local controller who passes it on to the assistant at the sales POS terminal who takes appropriate action at the terminal.

FIG. 7 of the accompanying drawings shows the redemption counterpart of the procedures of FIG. 6 as carried out over the Internet. Thus at steps S31, S32 and S33 the redeemer accesses the retailers ISP with a redemption request, for example to be used in payment for goods being purchased over the Internet. The retailers ISP passes, as in FIG. 4, the request of the communications interface of layer 400. The following steps are identical to those described with respect to FIG. 6 and accordingly have been given the same references and will not be described further.

As the purchase and redemption of a voucher involves the transfer of funds into/out of a dedicated bank account the manner in which funds are arranged and managed will now be described. As has already been described each voucher will belong to a particular voucher issuer which also identifies which fund account manages the voucher funds. It will be appreciated that a single fund account can carry funds for different products. Each fund has a “shadow bank account” which in the present embodiment is associated with a nominated physical bank account held at a financial institution.

FIG. 8 of the accompanying drawings shows the overall structure of fund ledgers for different retailers and different products.

In FIG. 8 sets of individual vouchers are shown at 60, 61, 62 and 63. Each of the vouchers has a value, its unique number, and a product definition, the product definition being shown as A1, A2, A3 and B6. Vouchers 60, 61 and 62 have all been issued on behalf of a retailer ABC stores, with A1 equalling vouchers which can be redeemed for white goods, A2 for groceries and A3 for records at participating branches at ABC stores Vouchers 63 have been issued on behalf of XYZ Stores, perhaps as a loyalty reward.

The respective product definitions are shown at 64, 65, 66 and 67 of FIG. 8 and as can be seen ABC stores have two separate fund accounts 68 and 69, one for products A1 and A2 and the other for products A3, whilst retailer XYZ has only one fund account 70.

These fund accounts are respectively shadowing accounts 71 and 72 at bank A and account 73 at bank B.

The core system in the present embodiment manages seven accounts relating to funds. These are as follows:

1) Fund Bank. There is one such account for each VIN This account shadows the physical external account (usually a bank account) holding the actual funds backing the live vouchers. The balance of this account is reconciled with the balance in the physical bank account. This is an EXTERNAL reconciliation. This represents that portion of the Fund that has already been transferred into the real fund bank account. The total value of the fund is the total of the three fund accounts: Fund Bank; Fund Sales Suspense; Fund Redeems Suspense.

2) Fund Sales Suspense. Again there is one of these accounts for each VIN. The balance of the account is the amount awaiting transfer into the general bank account from the real fund bank account in functional layer 500. Transfers will be carried out via an interbank transfer e.g. BACS.

3) Fund Redeems Suspense. Again there is one of these accounts for each VIN and is similar to the Fund Sales Suspense but is only for redemptions.

4) Fund revoked Suspense. Again there is one for each VIN. The balance in the account is the amount awaiting transfer from the general bank account of the system operator into the VIN owner's general bank account. The transfer will be carried out via an interbank e.g. BACS. This account is the equivalent of the Retailer Redeems Suspense account for vouchers which are expired, unclaimed, cancelled, etc. It is used to direct funds from back to the VIN owner.

5) Retailer Sales Suspense. There is one of these accounts for each retailer. The balance of this account is the amount awaiting transfer from the retailer bank account to general bank account on functional layer 500 of the system operator and typically represents the value of all vouchers sold during the day by this retailer regardless of VIN. The transfer will be carried out via an interbank transfer e.g. BACS.

6) Retailer Redeems Suspense. Again there is one for each retailer and is similar to the Retailer Sales Suspense account.

7) Funds Control. There is one such account for the whole system. Contra account for retailer transfers. The balance on this account is the total of all of the Funds Bank accounts (opposite sign).

The actual structure of the various accounts of the members using the system, the system operator and actual banks is shown in FIG. 16 with the appropriate functional layers. Take the example of a voucher being sold (at 90) by the retailer ABC. Thus at step A the suspense accounts of the core system are updated at the time that the voucher is sold. No funds are physically transferred at this point. Steps B show end of day transfers relating to retailer sales. The balance of each retailer sales suspense account is transferred to the overall funds control account. Instructions are given via the interbank clearing system to transfer the amount from the retailers bank account to the system operators bank account. Finally steps C show end of day transfers relating to the redemption of the vouchers. The balance of each fund sales suspense account is transferred to the funds bank account. Instructions are given via the interbank clearing system to transfer that amount from the system operators bank account to the funds bank account.

The following four examples illustrate how real cash associated with a voucher can move through the banking system just described.

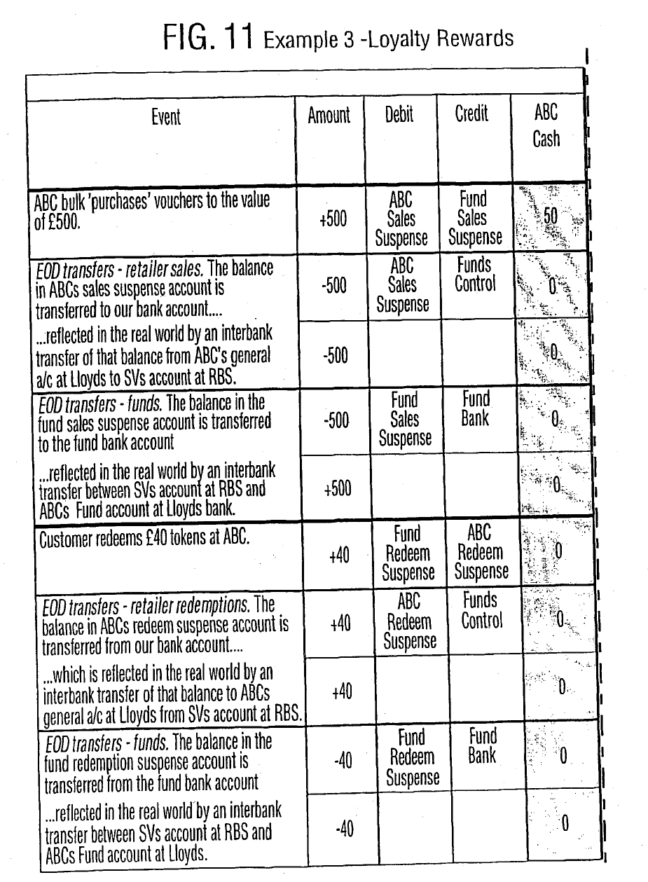

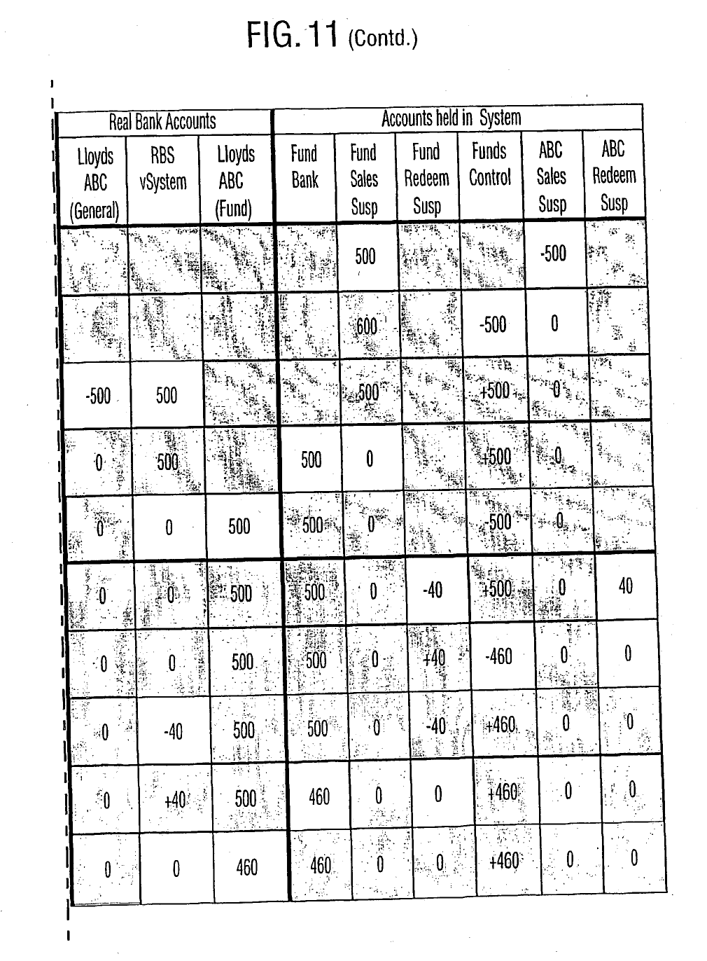

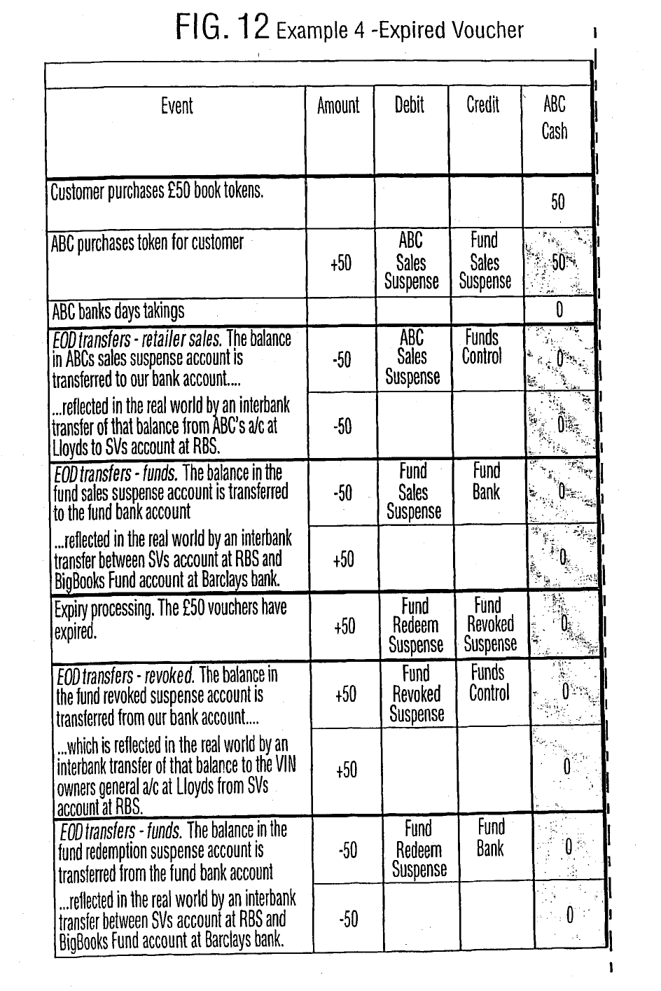

The four examples are illustrated in FIGS. 9, 10, 11 and 12. In the table of FIG. 9 a customer purchases 5×£10 vouchers from ABC books, who bank with Lloyds and gives it as a present to his nephew. The book token scheme is VIN34 and is run by Big Books. The bank account holding funds for this VIN is held at Barclays Bank in the name of Big Books but only the system operator has the authority to transfer funds in and out. The system operator holds a general account with RBS which is used client debits credits. In this example of £50 starts with the retailer selling the tokens and ultimately finishes with £40 in the bank account of the retailer who accepted the vouchers in place of cash and £10 in the fund bank account. During the period between issue and redemption the full £50 resides in the fund bank account. This is an example of a universal voucher.

The example of FIG. 10 is of a voucher for an individual retailer. ABC Stores run a voucher scheme for their stores so that the vouchers can only be purchased and redeemed from ABC Stores either at a physical store or via the Internet. A customer purchases 5×£10 vouchers from ABC Stores and gives it as a present to his nephew who uses £40 to purchase goods from ABC Stores who hold their own voucher funds but in a separate account which is under the control of the core system.

The third example, that of Table 11, is an example of a loyalty scheme run by ABC Stores. The scheme rewards customers with vouchers which can be redeemed at their own stores either physically or via the Internet. The total allocation at a particular issue date is £500. A customer uses a £40 voucher to purchase goods. ABC Stores holds a separate bank account under the control of the system operator containing funds to back the value of the issued vouchers.

The example of FIG. 12 is what happens if a voucher is not redeemed before the expiry date.

Having described the overall functionality and structure of the processing system real time functions of the central processor 1 there will now be described in relation to use of the system with the Interbank Communication System, as this is a likely scenario. Thus in the present embodiment voucher purchase is always triggered by a MTIxxxx request message received at the interface 2. In response to this message the central processor 1 always generates a MTIxxxx response message back to the message's source. Under normal circumstances the response message will contain the voucher number but if any errors are encountered during processing then the response will be a rejection of the purchase request.

Thus in response to the voucher purchase request the central processor 1 has the following functionality. It is emphasised that for security concerns all activity in the processor 1 must be via the interfaces 2 and 17.

The procedure is shown in the flow diagram of FIG. 12.

At step S100 a MTIxxxx voucher purchase request messages is sent to the central processor 1 and the message is received at interface 2, section 16 at step S101 and sent for validation at step S102 and for error processing at step S103. Should these latter two steps find the purchase request invalid an MTIxxxx to this effect is sent back to the interbank communication system 11 and also to the audit section of the data base MTIxxxx's as indicated at 50. If the purchase request is validated at steps S101 and S102 the purchase request is passed to step S104. At this point in the flow diagram a number of linked processes are carried out, it being appreciated that the purchase (and redemption of vouchers) always occur in real time so as to minimise delay at purchase and redemption. Thus at step S105 the voucher number is generated in the manner already described and at step S106 the newly generated voucher is transferred into the appropriate live voucher areas of the vouchers table 20 which have also already been discussed with regard to the main data base tables shown in FIG. 2 and which are indicated in this figure at 51 and 52. Similarly the successful generation of a voucher is audit processed at step S108 and again the result of this processing, is stored in the audit tables of the main data base, this being indicated at 50. Another consequence of the successful generation of a voucher is shown at step 109 which is a fee processing step which requires data from fee structure tables 53 in the main data base and which updates the fee transactions tables 54 in the main data base. Additionally at step S110, the central processor 1 carries out fund processing as the generation of the voucher requires the setting up of the equivalent funds in the Fund Accounts Transactions tables of the main database and also setting the appropriate data in the member tables of the main data base, these tables being respectively indicated at 55 and 56.

Finally the voucher response containing the voucher and product details are sent at step S111 to'the interbank communication system 11.

FIG. 13 of the accompanying drawings is a flow chart of the processing carried out in the central processor 1 when a voucher is redeemed. As will be described later management fee processing will actually be carried out in a batch process after the transactions have been logged.

It will be seen that the chart, as might be expected, is very similar to that of FIG. 12. Thus the steps and data tables involved in voucher redemption have been given the same reference numerals. However, at step S101 a redemption request is received, step S104 is concerned with the redemption process and at step S105 instead of voucher number generation the step refers to voucher number validation.

In addition step S106, in which the voucher is processed so that its value can be redeemed, causes an entry to be made giving the voucher information to the historic data tables of the main data base.

An important feature is that the fund balance providing the backing for live vouchers is always equal to the total represented by the live vouchers.

Thus the system just described has an integrity checking and reconciliation process which can be automatically triggered at preset times or which also can be manually requested at any time. The reconciliation process involves checking that the total value of live vouchers associated with a fund matches the balance in that funds ledger.

The processes are shown in the flow diagram of FIG. 14. Thus the process is initiated either by a user or a timer at step S50 reconciliation of the fund balances is carried out in step S51 utilising data from the fund accounts and fund accounts transactions tables 22 and 23 of the main data base 19. Voucher balance reconciliation is carried out in step S52 using details of the live vouchers stored in the live vouchers table 20 of the main data base. Finally a user alert or report is sent at step S53.

FIG. 16 shows the relationship between the retail world of functional layers 100 and 200, the core system of layer 400 and actual bank accounts shown in a functional layer 500. It is assumed that at 90 a cash voucher is sold by retailer ABC. As a result of the sale the tables 22 and 23 of the main database 19 are updated along with the generation of the coded number and an appropriate entry into the voucher table 20. As will be apparent at this time no physical transfer of funds is required. Thus at step A the suspense accounts of the core system are updated at the time that the voucher is sold. No funds physically transferred. Step B show end of day transfers—retailer sales. Balance of each retailer sales suspense account transferred to the overall funds control account. Instructions are given via the interbank clearing system to transfer that amount from the retailer's bank account to system operators bank account. Step C show end of day transfers—fund sales. Balance of each fund sales suspense account transferred to the funds bank account. Instructions are given via the interbank clearing system to transfer that amount from systems operator's bank account to the fund's bank account.

How transactions are posted to the various funds is shown on the table of FIG. 17 in which the direction of transfer is dictated by the sign of the balance transfer with −VE meaning transfer of funds into the general account of the system operator or from the retailer or VIN account and the +VE means transfer out from the general account of the system operator in to the retailer or VIN account.

Having now given a description of the general system and how it operates some fundamental features will now be apparent.

In particular when a purchaser obtains a cash voucher using one of the procedures which have been described the funds provided by the purchaser will be transferred into the funds account of the system but only in the form of a balance representing redemption value of the voucher. Vouchers are not individually listed and there will simply be an amount held in the fund account which is in total exactly the redemption values of all live (unredeemed) vouchers associated by their product table with that particular fund.

In a similar manner each voucher exists entirely independently of its purchaser. It is thus readily transferable to another person. In particular a voucher can be transferred with great simplicity over the Internet or verbally over the telephone as the recipient does not need to be linked in any way to the overall system.

Another feature of the system just described is that both the purchase and the redemption of a voucher can be carried out with minimal change to the normal terminal already present at a retailer location or used for Internet trading. Additionally a person presenting a voucher for redemption over the Internet can purchase goods without the need for supplying credit/debit card details.

In addition to the particular advantages of simplicity of operation and use of already existing facilities such as the Interbank Communication System the system particularly described hereinbefore provides a very significant technical advantage with regard to the amount of processing which has to be carried out and the need to allocate substantial volumes of memory for data storage. It is believed that the system described has applications in many fields in which money has to be transferred and if it is successful the number of transactions to be handled by the system will be extremely large. Thus the feature that vouchers are not allocated to individuals and that the funds supporting live vouchers are not subdivided to reflect individual vouchers values give a consequent reduction in the amount of processing to be carried out and in the usage of memory space.

The system just described also has a high degree of security as a cash voucher cannot be used unless funds have been committed with the request. Thus a voucher cannot be redeemed unless the funds have been committed to the operator of the system. Additionally the manner in which a coded voucher number contains the constraints which define it as a product means that the table holding the unredeemed vouchers will indirectly represent an accurately defined cash value which will be shadowed in the Fund Ledger Table 22 of FIG. 2 and which will have a counterpart cash balance in an actual bank account. Thus any change to increase or decrease the live vouchers in the voucher table 20 must be mirrored in the Fund Ledger Table 22 and on the actual bank account.

1. An electronic processor system for use in processing cash transactions comprising an electronic processor and a database, the processor comprising:
1) an interface for receiving a request from a member using the system for generating a coded number representing a desired cash value to be purchased at a remote terminal, for receiving a request that a number previously allocated may be redeemed, for transmitting to the remote terminal a generated number and for transmitting a message to a terminal indicating that a received request for redemption is valid;
2) a validation section for determining whether or not received requests are valid;
3) a number generation section for generating a coded number in response to a valid request; and
4) a storage section for storing each number generated in response to a valid request in a first table of the database and for storing the total value of cash represented by issued coded numbers which have not been redeemed in a Fund table and for transferring a coded number the redemption of which has been validated to a second table and decrementing the total value in the Fund table by the value represented by each coded number for which a validated redemption request is received so that every coded number issued can never cause more than one increase in the value represented in the fund table and every coded number redeemed can cause only one decrease in the stored value.

2. A system according to claim 1, wherein the database holds a voucher table containing details of all generated coded numbers which have not been redeemed.

3. A system according to claim 2, wherein the database holds a fund ledger table for each member storing the balance of all generated coded numbers relating to that member which have not been redeemed.

4. A system according to claim 3, wherein each fund ledger table shadows money either held or in transit to or from a physical bank account so that the total sum in the table represents the value of unredeemed numbers.

5. A system according to any preceding claim, wherein the processor is adapted to generate the coded number so as to incorporate constraints placed upon the redemption of the coded number, the constraints being represented as a first sequence of digits which form part of the number.

6. A system according to claim 5, wherein the constraints are defined externally of the system.

7. A system according to claim 4 or claim 5, wherein the processor is adapted to generate each coded number so that the number has a second sequence of digits which identify the member on behalf on whom the number has been generated.

8. A system according to any one of claims 5 to 7 wherein the central processor is adapted to generate for members statistical tables profiling aspects of coded numbers purchased and redeemed based on said constraints.

9. A system according to any preceding claim, wherein each coded number includes an initial set of six digits representing an International identification number (IIN) allocated to the member on behalf of whom the coded number has been generated.

10. A system according to any preceding claim wherein the number generating section is adopted to generate a random multi-digit identification number as part of the coded number in response to a request from a member and at least one check digit

11. A system according to claim 10 wherein in the number generation section is adapted to check that any randomly generated identification number has not already been issued.

12. A system according to and one of claims 5 to 11 when dependent on claim 4 wherein the central processor is adapted to carry out a security check by measuring the ratio of the number of unredeemed coded numbers for a member and with a particular constraint code against the total number of numbers for that constraint code which could be generated, and by using a warning if the ratio is above a threshold.

13. A system according to any preceding claim wherein the processor is adapted to reconcile the total value in the fund table attributed to issued but unredeemed vouchers against physical funds held in or in transit to bank accounts holding only balances related to that fund.

14. A system according to any preceding claim, wherein the database includes a table of members who can have coded numbers generated on their behalf and who can have coded numbers redeemed on their behalf, and wherein the processor is adapted to accept messages requesting the generation of coded numbers or the redemption of coded numbers after checking that the message has been issued by a member listed in the member table.

15. A system according to any preceding claim, wherein the coded number is nineteen digits long including the IIN number.

16. A system according to any preceding claim and including a plurality of remote terminals from which requests for coded numbers can be issued.

17. A system according to claim 16 and including a plurality of remote terminals from which requests for the redemption of coded numbers can be issued.

18. A system according to claim 17, wherein said at least one terminal is an Internet terminal.

19. A system according to any one of claims 15 to 18, wherein at least one terminal has an associated printer for printing the coded number after a request has been validated and a number issued.

20. A system according to claim 19, wherein said printer is adapted to print as a bar code at least part of said coded number.

21. A method of processing cash transactions utilising an electronic processor and a database, the method comprising the steps of:
receiving a request from a member using the system for generating a coded number representing a desired cash value to be purchased at a remote terminal;
determining whether or not the request is valid;
generating a coded number is response to a valid request;
transmitting to the remote terminal a generated number;
receiving a request that a number previously allocated may be redeemed; transmitting a message to a terminal indicating that a received request for redemption is valid in response to validation of the number;
storing each number generated in response to a valid request in a first table of the database;
storing the total value of cash represented by issued coded numbers which have not been redeemed in a Fund table;
transferring a coded number the redemption of which has been validated to a second table;
decrementing the total value in the Fund table by the value represented by each coded number for which a validated redemption request is received so that every coded number issued can never cause more than one increase in the value represented in the fund table and every coded number redeemed can cause only one decrease in the stored value.

22. A method according to claim 21, wherein generated coded numbers which have not been redeemed are stored in a voucher table in a database.

23. A method according to claim 22, wherein the database holds a fund ledger table for each member storing the balance of all generated coded numbers relating to that member which have not been redeemed.

24. A method according to claim 23, wherein each fund ledger table shadows money either held or in transit to or from a physical bank account so that the total sum in the table represents the value of unredeemed numbers.

25. A method according to any one of claims 21 to 25, wherein the processor is adapted to generate the coded number so as to incorporate constraints placed upon the redemption of the coded number, the constraints being represented as a first sequence of digits which form part of the number.

26. A method according to claim 25, wherein the constraints are defined externally of the system.

27. A method according to claim 24 or claim 25, wherein each coded number is generated so that the number has a second sequence of digits which identify the member on behalf on whom the number has been generated.

28. A method according to any one of claims 25 to 27 generating for members statistical tables profiling aspects of coded numbers purchased and redeemed based on said constraints.

29. A method according to any one of claims 21 to 28, wherein each coded number includes an initial set of six digits representing an International identification number (IIN) allocated to the member on behalf of whom the coded number has been generated.

30. A method according to any one of claims 21 to 29 wherein the number generating section is adopted to generate a random multi-digit identification number as part of the coded number in response to a request from a member and at least one check digit

31. A method according to claim 30 wherein any randomly generated identification number has not already been issued.

32. A method according to and one of claims 25 to 31 when dependent on claim 24 wherein a security check is carried out by measuring the ratio of the number of unredeemed coded numbers for a member and with a particular constraint code against the total number of numbers for that constraint code which could be generated, and by issuing a warning if the ratio is above a threshold.

33. A method according to any one of claims 21 to 32 wherein reconciliation is carried out on the total value in the fund table attributed to issued but unredeemed vouchers against physical funds held in or in transit to bank accounts holding only balances related to that fund.

34. A method according to any one of claims 31 to 33, including storing a table of members who can have coded numbers generated on their behalf and who can have coded numbers redeemed on their behalf, and wherein the processor is adapted to accept messages requesting the generation of coded numbers or the redemption of coded numbers after checking that the message has been issued by a member listed in the member table.

35. A method according to any one of claims 21 to 34, wherein the coded number is nineteen digits long including the IIN number.

36. A storage medium for storing processor implementable instructions for controlling a processor to carry out the method of any one of claims 21 to 34.

37. An electrical signal carrying processor implementable instructions for controlling a processor to carry out the method of any one of claims 31 to 34.

38. A coded number as generated by the method of any one of claims 1, 25, 27, 29 or 30 when transmitted over a suitable medium.

39. A terminal for communicating with an electronic processor system in accordance with any one of claims 1 to 21.
